(19) United States
(12) Patent Application Publication
(10) Pub. No.: US 2005/0268412 A1
(43) Pub. Date: Dec. 8, 2005

(54) Shaped washing elements for vehicle wash systems

(75) Inventor: Daniel Pecora, Palatine, IL (US)

Correspondence Address: MICHAEL P. MAZZA, LLC, 686 CRESCENT BLVD., GLEN ELYN, IL, 60137, US

(73) Assignee: Erie Brush & Manufacturing Corporation

(21) Appl. No.: 10/859,696

(22) Filed: Jun. 3, 2004

(51) Int. Cl. B60S 3/04

(52) U.S. Cl. 15/97.3; 15/230.16; 15/53.2

(57) ABSTRACT

A shaped washing element used in a car wash system, having a proximal portion with a generally rectangular shape in length and width, and a shaped distal portion which is not generally rectangular-shaped in length and width. The washing element may be made of any material suitable for washing and/or polishing vehicles. Shaped washing elements according to the present invention are believed to provide increased cleaning efficiency, greater durability, and less propensity for damaging vehicles passing through the car wash system.

### BACKGROUND OF THE INVENTION

The present invention relates to the field of washing apparatus and machines for vehicles such as cars, trucks, buses, trains, recovery vehicles, etc. More specifically, the invention is directed to designs for washing and/or polishing of vehicles using curtains and/or brushes typically employed in vehicle wash systems.

Generally, automatic vehicle washing systems include various mechanisms to wash vehicles, including hanging curtains, also referred to as mitters or hangdowns, among other names, that are suspended vertically in the vehicle conveyor line, tunnel, roll-over or wash or polish bay (“vehicle wash system”) (e.g., FIG. 1) and/or brushes that extend radially from rotating machines which may have vertical (e.g., FIG. 2) or horizontal axes. Mechanisms are typically employed to move the curtains or brushes, causing them to oscillate or rotate or the like so that they contact as many portions of the vehicle as possible as it passes through the vehicle wash system, or a wash machine passes over the vehicle (depending upon the system employed). Vehicle wash systems also may employ rotating machines with brushes, cloths, etc., extending radially outward from the machines to wash the sides and/or top and rear of vehicles.

Prior art patents describe, for example, curtains consisting of fabric panels cut into multiple strips and suspended vertically from an overhead support structure. Some prior patents reference curtains with variable lengths to prevent entanglement with successive rows. Still other prior patents disclose the use of pie-shaped or rectangular curtains with slits at the bottom to provide independent contact surfaces; for example, the pie-shaped cloth elements may be oriented in circular arrays for rotating brushes, as disclosed in U.S. Pat. No. 6,035,482, which is incorporated by reference in its entirety into this application.

Prior art vehicle wash systems have encountered difficulty in thoroughly cleaning vehicle surfaces without grabbing or catching on vehicle parts such as rear wipers, or without thoroughly cleaning side panels with dips and undulations, or lower car rocker panels, which are typically convex-shaped.

Despite advances in vehicle wash systems and apparatus, there is still a need for providing a vehicle wash system with improved cleaning capabilities and enhanced durability which also minimizess possible damage to the vehicle being washed.

### SUMMARY OF THE INVENTION

The present invention overcomes disadvantages of prior car wash systems and apparatus, while providing new advantages not previously obtainable.

In one embodiment of the present invention, a shaped washing element for use in a vehicle wash system is provided. The washing element includes a proximal portion having a length and width forming a generally rectangular shape. The washing element also includes a shaped distal portion which is not generally rectangular-shaped in length and width, for contacting the surface of a vehicle to be washed. The washing element may include any material suitable for washing and/or polishing vehicles, including but not limited to (or combinations thereof): cloth; shallow pile synthetic lambs' wool; deep pile synthetic lambs' wool; a felt or synthetic felt material; or foam washing/polishing material. The washing elements may hang vertically down to form one or more downwardly extending curtains. Alternatively, the washing elements may be oriented generally perpendicular to, and extend radially outward from, an axis of a rotating cleaning apparatus; this axis may extend either generally vertically, generally horizontally, or at any other angle from the ground.

In a preferred embodiment, shaped distal portions of adjacent washing elements may be provided, either on hang-down curtains or on rotating brushes, for example. These shaped distal portions may include shaped flaps and/or (e.g., rectangular, sinusoidal or other cross-sectional shapes) flaps or slats; these flaps or slats may be shaped or may, but need not have distal ends consisting of divided, shaped washing fingers. Such fingers are preferably about 2-25 inches in length, and more preferably about 2-6 inches in length. The shaped distal portions may be generally hemispherical (e.g., with a radius of 3/16 to 4 inches), generally V-shaped, generally curvilinear, or form other non rectangular shapes. The shaped distal portions of the washing elements may first contact the vehicles facewise (i.e., the width of the distal portion is oriented to face the surface of the vehicle to be contacted), edgewise, or at some angle in between, depending upon user preference.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIGS. 1 and 2 are perspective views of a prior art curtain, and vertically oriented rotating equipment utilizing rotating brushes, respectively, used in conventional vehicle wash systems;

FIG. 3 is a schematic view of portions of a curtain having alternative, shaped distal ends according to one preferred embodiment of the present invention;

FIG. 4 is a schematic view similar to FIG. 3 showing a curtain according to various embodiments of the present invention with exemplary, differently-sized flaps having hemispherically-shaped distal ends;

FIG. 5 is a perspective view showing a rotating brush with a vertical axis, with each separate clump, piece or element of the rotating brush having shaped ends;

FIGS. 6 and 7 are perspective views of one embodiment of the car wash system of the present invention using shaped, hang-down curtains; and

FIG. 8 is an enlarged view of the circled portions of FIGS. 6 and 7 illustrating the shaped distal ends of the curtains.

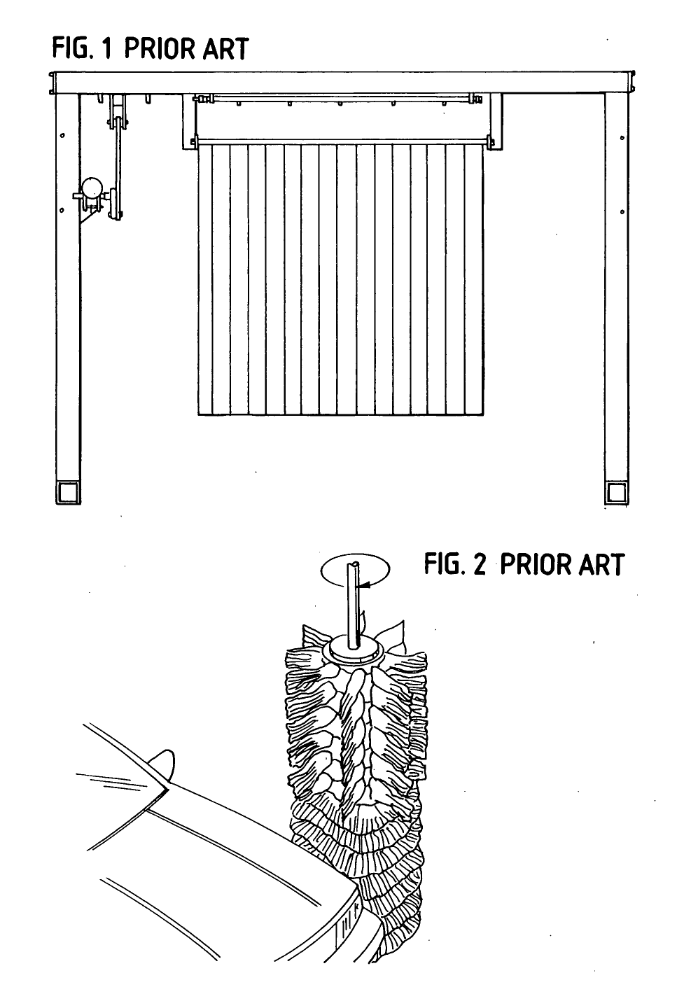

### DEFINITION OF CLAIM TERMS

The terms used in the claims of the patent as filed are intended to have their broadest meaning consistent with the requirements of law.

“Curtain” means a washing element, which may be divided into slats or flaps.

“Fingers” mean smaller, distal portions of a washing element that may form divided portions of a slat or flap.

“Washing element” means material designed to contact a vehicle to be washed, including but not limited to rotating brushes, hang-down curtains, etc.

Where alternative meanings are possible, the broadest meaning is intended. All words used in the claims are intended to be used in the normal, customary usage of grammar and the English language.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

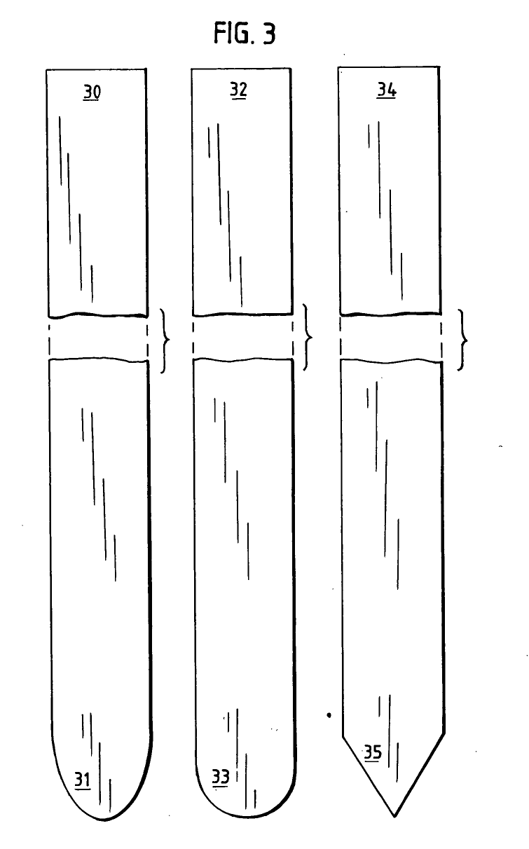

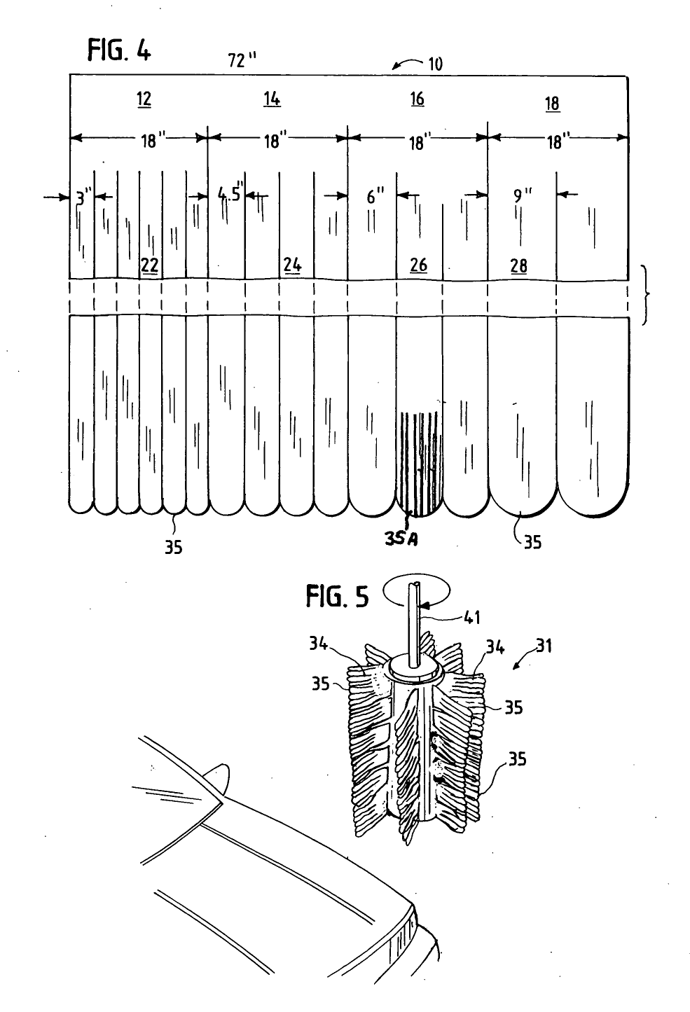

In accordance with a preferred embodiment of this invention, a washing element, which can be a vertically suspended curtain or a brush element radially extending from a rotating machine, is designated with the reference numeral 10. In alternative embodiments, the curtain or brush which is washing element 10 can have various dimensions. Referring to FIGS. 3-4, a curtain 10 may have a slat or flap 30, 32, 34 having a width from about 2-3 inches up to about 120 inches (cars) or 200 inches (oversize for, e.g., trucks or buses) depending on the vehicle to be washed and the structure of the vehicle wash system. Each brush element within a rotating brush array may have a length extending from the core axis of anywhere from about 3 inches to about 30 inches. These widths and/or lengths are dependent upon on whether the curtain or brush is intended to wash cars, buses, trucks, trains, etc, and which parts of the vehicle it will be washing or polishing, as well as the owner's preference.

Where washing element 10 is a curtain, each flap 22, 24, 26, 28 (see FIG. 4) may, but need not, be divided into narrower washing fingers 35A (see slat 26 of FIG. 4), having various dimensions, such as a width of about 3/16 inches up to 3 inches, for example. The fingers may have a length of about 2-25 inches, for example, depending upon the length of the curtain. The oscillating and/or rotating speed of the curtain or brush, as well as the selected length and width of the washing fingers, affects washing performance. Theoretically, narrower fingers provide higher cleaning efficiency. However, wider fingers tend to be more durable and withstand more wear and tear with less ripping or tearing.

For example, FIG. 4 shows an embodiment in which curtain 10 is 72 inches wide. To show the wide range of combinations available with this invention, FIG. 4 shows curtain 10 divided into sections 12, 14, 16, or 18 which can themselves be subdivided into flaps of different sizes 22, 24, 26, or 28 for more cleaning choice. In one embodiment, section 12 of curtain 10 is subdivided into flaps 22. For example, as shown in FIG. 4, section 12 of curtain 10 is 18 inches wide with each of the six flaps having a width of 3 inches.

In an alternative embodiment, section 14 of curtain 10 is subdivided into four flaps 24. In FIG. 4, for example, section 14 of curtain 10 may again be 18 inches wide with each of the four flaps having a width of 4.5 inches. In this embodiment, the curtain 10 follows the pattern of section 14 where slats 24 are 4.5 inches wide across the entire width of curtain 10. Similarly, section 16 of curtain 10 may include three flaps 26 each with a width of 6 inches, while section 18 of curtain may include two flaps 28 each with a width of 9 inches. FIG. 4 is provided only to illustrate different slat/finger combinations of shaped curtains that may be provided, not to indicate that a curtain should be manufactured which has such different combinations.

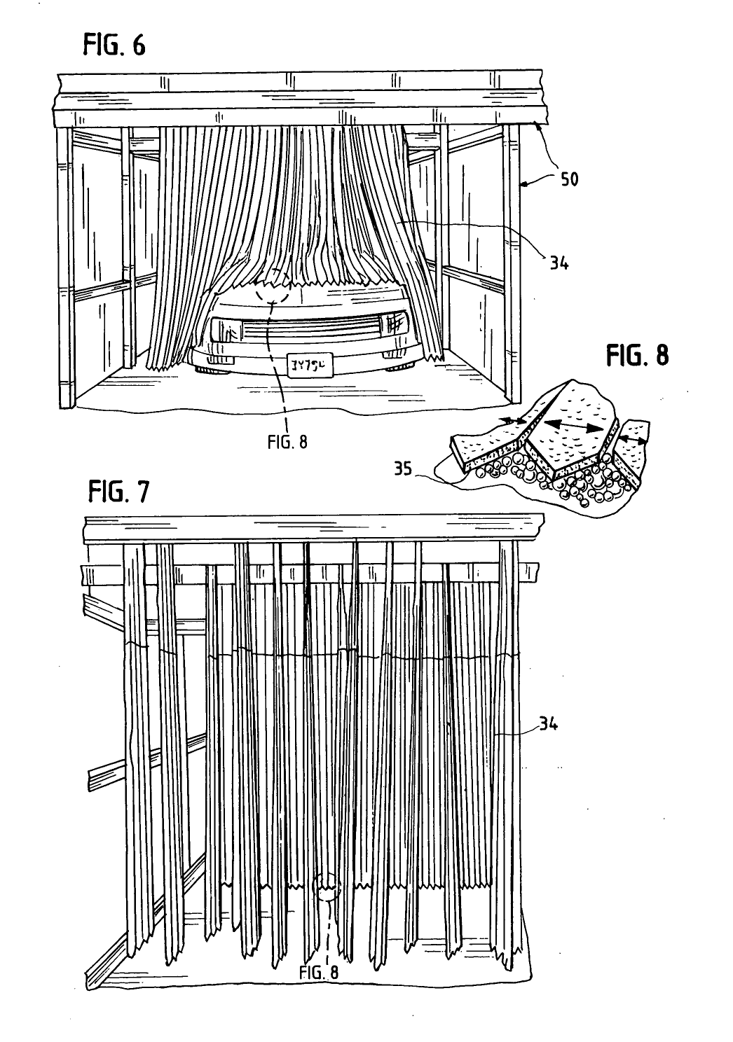

As another example, FIG. 5 shows a rotating brush 31 with a vertical axis 41. Each separate clump, piece or element 34 of the rotating brush may include shaped ends 35 having divided fingers, for example. (Shaped ends 35 contrast with the ends of the rotating-brush shown in prior art FIG. 2 which are flat, and thus rectangular-shaped.) Referring now to FIGS. 6-8, one embodiment of the car wash system of the present invention using hang-down curtains having shaped distal ends is shown. Frame 50 supports shaped curtains 34 having shaped distal ends 35.

The preceding examples provide specific values for curtain or brush width, as well as specific values for finger or slit width and number. These examples, however, are not meant in any way to limit this invention to the specific values described in the examples; rather, they are meant to provide an idea of the wide range of combinations of curtain and finger widths this invention envisions. This invention contemplates size variations for any shaped washing element which may be employed in a vehicle washing system. These shaped washing elements may have many fingers or no fingers, and may utilize as many separate distal portions as are necessary to efficiently clean and protect the vehicle. The width of each finger may but need not be equal; for example, thicker and thus less grabby fingers may be used for those fingers that contact the outer periphery of vehicles where antennas and mirrors may be located, for example.

In accordance with each of the embodiments described above, the fingers or slits on curtain or brush 10 may include the additional feature of a non-rectangular bottom or distal portion. In FIG. 3, each flap 30, 32 and 34 represents a part of curtain 10, and includes a distal portion 31, 33, 35 which is a shaped washing element. These flaps may have the dimensions specifically described for the examples above, or other dimensions such as the ranges described more generally above. The shaped distal ends are preferably reshaped over time if the ends rip or tear at their contours through use.

It is understood that the shaped distal portions of curtain 10 are not the only portions of the curtain to contact a vehicle during washing. However, the shaped distal portions are believed to provide a substantial washing and/or polishing and protecting function. In addition, the rectangular distal portions are sometimes thought to be responsible for many past problems when the curtains grab and/or become entangled with vehicle parts. These distal portions are also the portions of the curtain that tend to wear first, prior to other parts of the curtain.

Flap 32 in FIG. 3 has a curvilinear-shaped distal portion 33. FIG. 4 also shows flap 34 with distal portions 35 in the shape of a hemisphere or semicircle. Finally, FIG. 3 shows flap 34 with distal portion 35 in a V-shaped configuration. Vehicle washing elements may catch or grab vehicle parts such as side view mirrors, antennae, and front and rear wipers. It was discovered that washing elements with non-planar distal portions, such as V-shaped, generally V-shaped, curvilinear such as semicircular, or other non-rectangular shapes, surprisingly provide less propensity to grab or catch on vehicles and vehicle parts during the washing process. Thus, washing elements having shaped distal portions decrease the risk of damage to vehicle components during washing. It is also believed that washing elements with shaped distal portions increase cleaning efficiency by reaching into or over crevices, surface undulations in the vehicle body, and other areas on the vehicle that were sometimes not thoroughly cleaned using prior systems.

In one preferred embodiment shown in FIG. 3, shaped distal portion or element 33 forms a hemispherical shape having a radius that is preferably in the range of less than or equal to about 1-3 inches. Elements 31 and 35 may have generally similar dimensions.

Washing element 10 may be made of various materials, such as but not limited to the following: shallow pile synthetic lambs' wool; deep pile synthetic lambs' wool; cloth, felt, foam such as closed cell foam; or any other material suitable for washing or polishing vehicles. Use of deep pile synthetic lambs' wool material and other appropriate materials are described, for example, in U.S. Pat. Nos. 5,077,859 and 5,134,742 to Ennis.

Washing elements 10 of this invention may be suitable for wet washing cars and other vehicles, as in typical car wash apparatus. Washing elements 10 may also be suitable for wet washing and wet or dry polishing of cars and other vehicles.

Other changes and modifications constituting insubstantial differences from the present invention, such as those expressed here or others left unexpressed but apparent to those of ordinary skill in the art, can be made without departing from the spirit and scope of the present invention and without diminishing its attendant advantages. It is, therefore, intended that such changes and modifications be covered by the following claims.

1. A shaped washing element for use in a vehicle wash system, comprising:
a proximal portion;
a shaped distal portion which is not generally rectangular-shaped in length and width, for contacting the surface of a vehicle to be washed;
wherein the washing element comprises any material suitable for washing and/or polishing a vehicle.

2. The shaped washing element of claim 1, wherein the proximal portion comprises a flap having a length and width forming a generally rectangular shape.

3. The shaped washing element of claim 2, wherein the flap comprises a plurality of divided fingers.

4. The shaped washing element of claim 3, wherein the fingers each have a length of between about 2-25 inches.

5. The shaped washing element of claim 1, wherein the washing element hangs vertically alone or with other shaped washing elements, the shaped washing elements forming part of one or more downwardly extending curtains.

6. The shaped washing element of claim 1, wherein the washing element is oriented generally perpendicular to, and extends radially outward from, an axis of a rotating cleaning apparatus.

7. The shaped washing element of claim 6, wherein the axis of the rotating cleaning apparatus extends generally vertically.

8. The shaped washing element of claim 6, wherein the axis of the rotating cleaning apparatus extends generally horizontally.

9. The shaped washing element of claim 1, wherein the washing element comprises a brush element.

10. The shaped washing element of claim 1, wherein the distal portion is generally V-shaped.

11. The shaped washing element of claim 1, wherein the distal portion forms a generally hemispherical shaped.

12. The shaped washing element of claim 1, wherein a distal edge of the distal portion is substantially curvilinear in shape.

13. The shaped washing element of claim 1, wherein the distal edge of the distal portion is curvilinear in shape.

14. The shaped washing element of claim 1, wherein the washing element comprises one or more of the following materials: cloth; shallow pile synthetic lambs' wool; deep pile synthetic lambs' wool; felt; synthetic felt; or foam.

15. A vehicle washing and/or polishing system using shaped washing elements, comprising:
one or more curtains, one or more of the curtains including one or more washing element flaps, each of the flaps having an extending proximal portion and a shaped distal portion with a non-planar distal edge for contacting the surface of a vehicle to be washed;
wherein the washing elements comprise any material suitable for washing and/or polishing a vehicle.

16. The vehicle washing and/or polishing system of claim 15, wherein the one or more curtains are oscillating.

17. The vehicle washing and/or polishing system of claim 15, wherein the one or more curtains are fixed.

18. A vehicle washing and/or polishing system using shaped washing elements, comprising:
one or more rotating brushes, at least one of the one or more rotating brushes including one or more washing element flaps, each of the flaps having an extending proximal portion and a shaped distal portion with a non-planar distal edge for contacting the surface of a vehicle to be washed;
wherein the washing elements comprise any material suitable for washing and/or polishing a vehicle.

19. A vehicle washing and/or polishing system using shaped washing elements, comprising:
one or more rotating brushes, at least one of the one or more rotating brushes including one or more washing element flaps, each of the flaps having an extending proximal portion and a shaped distal portion with a non-planar distal edge for contacting the surface of a vehicle to be washed;
wherein the washing elements comprise any material suitable for washing and/or polishing a vehicle.

20. The vehicle washing and/or polishing system of claim 19, wherein one or more of the flaps include washing fingers.

21. A vehicle washing and/or polishing system using shaped washing elements, comprising:
a plurality of brush elements rotating about an axis, each of the brush elements having an extending proximal portion, the proximal portion of the brush elements terminating in a shaped distal portion having a non-rectangular shaped distal edge for contacting the surface of the vehicle to be washed;
wherein the washing elements comprise any material suitable for washing and/or polishing vehicle.

22. The vehicle washing and/or polishing system of claim 21, wherein the non-planar distal edge is substantially curvilinear in shape.

23. The vehicle washing and/or polishing system of claim 21, wherein the non-planar distal edge is generally V-shaped.

24. The vehicle washing and/or polishing system of claim 21, wherein the non-planar distal edge is hemispherical in shape.
